(19) United States
(12) Patent Application Publication
(10) Pub. No.: US 2006/0176690 A1
(43) Pub. Date: Aug. 10, 2006

(54) Multi-function emergency ready light

(76) Inventor: Se Kit Yuen, Hong Kong (CN)

Correspondence Address: ARTHUR KING MA, 1030 CORONADO DRIVE, ARCADIA, CA, 91007, US

(21) Appl. No.: 11/079,790

(22) Filed: Mar. 14, 2005

(30) Foreign Application Priority Data
Feb. 7, 2005 (HK) 05101043.0

(51) Int. Cl. F21L 4/02; F21V 31/00; F21V 29/00

(52) U.S. Cl. 362/200; 362/184; 362/158; 362/294

(57) ABSTRACT

The present invention is relates to a multi-function emergency ready light and more particularly, to a multi-function emergency ready light which is having five sources of lights, ability of providing lights for up to 8 hours continuously and a battery recharge plug extended from outer end said multi-function emergency ready light allowing user to recharge a battery. Users may carry this light and use said LED super light bulb for distant lighting at outdoor or indoor. Thus, this renovated light is multi-purpose, energy-saving and environmental friendly. It is an important light source in the police force, fire department, emergency rescue, disciplined army and civil use.

### BACKGROUND OF SAID PRESENT INVENTION

1. Field of Invention

The present invention is relates to a multi-function emergency ready light and more particularly, to a multi-function emergency ready light which is having five sources of lights, ability of providing lights for up to 8 hours continuously and a battery recharge plug extended from outer end said multi-function emergency ready light allowing user to recharge a battery.

2. Description of Related Arts

Military, law enforcement, fire and rescue personnel, security personnel, hunters and recreational boaters among others for nighttime surveillance in any application commonly use lantern, where lighting is required. Nowadays, such application is highly demeaned in all situations at nighttime. Conditions of use are highly varied, but generally require the light to deliver a desired field of view at long distances, be reliable, durable and field maintainable in order for it to be practically used in the designed applications. Typically the light is hand carried and must be completely operable using simple and easily access manual controls, which do not require the use of two hands. In prior art xenon short-arc searchlights or illumination systems, whether handheld, portable or fixed mounted, the luminance distribution of the arc has been positioned facing in the direction of the beam (cathode to the rear), to provide a uniform beam pattern when the arc is at the focal point of the parabolic reflector. When the arc is moved slightly beyond (or slightly rearward of) the reflector's focal point, the combination of a placing all available light in the high magnification section of the reflector and collecting it in a slightly convergent manner produces roughly twice the operating range as a conventional anode-forward device.

Also, all prior arts of lanterns are focusing mainly of power sources or power supply to power up lanterns. Seldom of prior arts are aiming to improve lighting angles as most lanterns are used with handheld or placed on a table/floor or even placed with a hat. However, it is very obviously that lantern with an ability to rotate with certain degree of angles s so needed.

U.S. Pat. No. 6,685,337 provides a lanterns which combine both a flashlight with a candle together to ensure said lantern can still light up when power source is done or batteries are all used up. However, the lighting range, lighting angles and the lighting power of a candle are minimal. Such lantern light up by a candle will not be the most useful tool in an event of a big area.

U.S. Pat. No. 6,629,767 discloses a lantern with a batteries compartment with shock absorber lining to protect batteries contained therein from damage due to excessive shock applied to said batteries. Again, this lantern is only aiming a power supply to said lantern but lighting range and lighting angle are being ignored.

U.S. Pat. No. 6,702,452 provides a lantern with a tripod supporting legs. The mounting is a tripod mount so that the portable searchlight may be fixed in the field to a tripod with the second device. The mounting on the handle is a thumbscrew mount to permit mounting of an optical detection device onto the searchlight and rigidly fixed to the housing. However, this lantern provide without no ability to move any angle to obtain a better light range.

### SUMMARY OF SAID PRESENT INVENTION

The main object of the present invention is to provide a multi-function emergency ready light having at least 5 light sources.

Another object of the present invention is to provide a multi-function emergency ready light having at least five light sources and three of said five light sources are LED for long distance lighting.

Another object of the present invention is to provide a multi-function emergency ready light having an ability to adopt difference power source supplies.

Accordingly, to achieve the above objects, a rechargeable compact fluorescent comprises:
a three-dimensional rectangular-cylinder housing, inside of it contains at least five sources of lighting wherein three of said sources of lighting are LED, power saving illuminants; and
a plurality of reflector is fixed around said mean of light source; and
a transparent front flat board; and
a plurality of heat release covers attached at the end portion of said housing; and
a sealed packing collar is connecting a inner portion of said transparent front flat board and said reflector which resides inside of an annular nut, said annular nut providing a fixed position and a disassembled position on front portion of said housing. Surface of said annular nut, which is located in front of said housing, set an annular shockproof nut. It is made of rubber or other soft material to prevent said rechargeable halogen lantern from shocks or quakes when excessive external force applied to it; and

### BRIEF DESCRIPTION OF SAID DRAWINGS

FIG. 1 is a side view of the present invention.

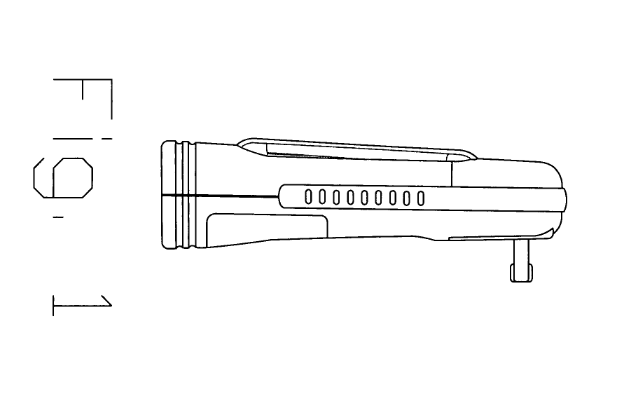

FIG. 2 is a side sectional view thereof.

FIG. 3 is a plan view thereof.

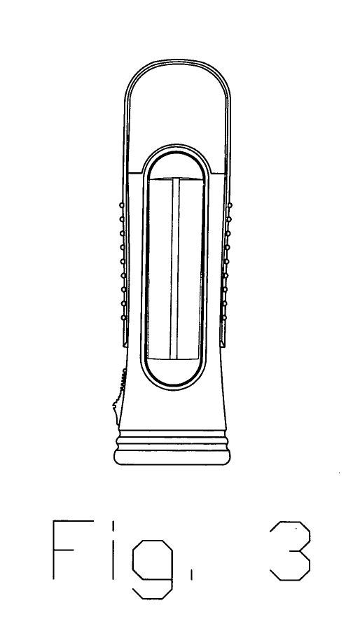

FIG. 4 is an underneath view thereof.

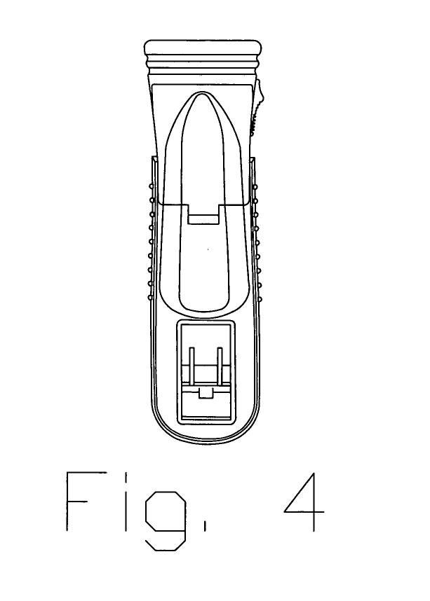

FIG. 5 is a front view thereof.

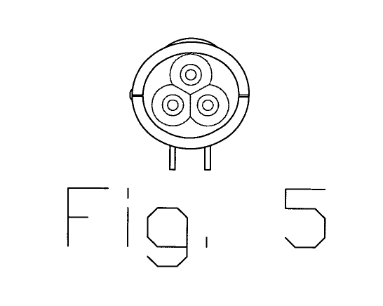

FIG. 6 is a rear view thereof.

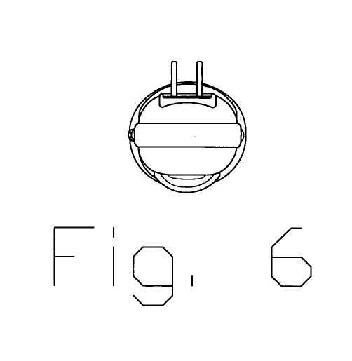

FIG. 7 is another side view thereof.

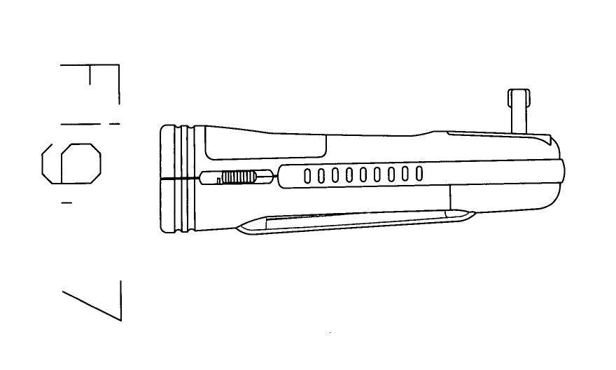

### DETAILED DESCRIPTION OF SAID PREFERRED EMBODIMENT

This multi-function emergency ready light comprises a three-dimensional rectangular-cylinder housing, inside of it contains at least five sources of lighting wherein three of said sources of lighting are LED, power saving illuminants. In the front of said housing (1) are three LED super light bulbs (2), three parabolic reflector mirrors (3), and a front flat transparent board (4). Said front flat board (4) has three bulge mirrors (3). Inside of said front flat board (4) is sealed with said reflectors (3) which reside inside an annular nut (6). Said annular nut (6) can be fixed or disassembled on the front of the housing (1).

Inside of said housing (1) which is generally of three-dimensional rectangular-cylinder in shape In the front of said housing (1) are three LED super light bulbs (2), three reflector mirrors (3) which is generally parabolic shape, and a front flat transparent board (4). Said front flat board (4) has three bulge mirrors (3). Inside of said front flat board (4) is sealed with said reflectors (3) which reside inside the annular nut (6). Said annular nut (6) provides a fixed position and disassembled position on said front portion of said housing (1).

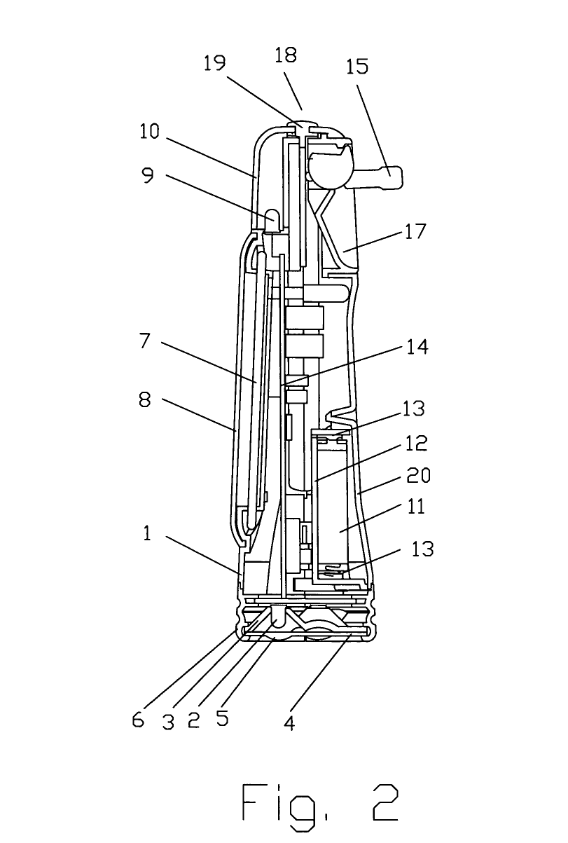

Referring to FIG. 2, there is a long-life cold-cathode light tube (7) affixed to a center portion of housing (1). On an upper end of said long-life cold-cathode light tube (7), there is a light shade (8) made of glass or transparent material. At the end of said housing (1) there is a long-life cold-cathode light (9). On top of said long-life cold-cathode light (9) there is a semi-transparent night light shade (10). Inside said housing (1) there are rechargeable batteries (11). Said rechargeable batteries (11) are flexibly installed inside the independent battery chamber (12). At both front and rear end of said rechargeable batteries (11) there are contact hardware plate (13) which are connected to an electrical circuit board (14) inside said housing (1). They supply power to said electrical circuit board (14) for lighting and emergency use. At a bottom portion of said battery chamber (12) there is a battery door (20) which can be sealed. The municipal power source enters said housing (1) through an A/C plug (15) and then connects to said electrical circuit device (14) inside said housing (1) through a power cord to recharge said batteries (11) inside said housing (1). Said power from said rechargeable batteries (11) is connected to a switch (16) and then to said electrical power device (14) to control an activation of all light sources. Said A/C plug (15) can be flexibly stored at a storage room (17) at end portion of A/C plug (15) to form a horizontal line with said housing (1). When said A/C plug (15) is pulled out to form a perpendicular line with said housing (1) and then plugged into the A/C outlet, it allows recharging said rechargeable batteries (11).

Said housing (1) is surrounded by a anti-slippery rope (19) which is made of soft material. It provides comfort to the user when holding the rechargeable photoelectron multi-function emergency ready light.

In other words, this multi-function emergency ready light provides a convenient recharging method for its user. After the light is fully recharged, it provides usage for eight hours continuously. Placing said multi-function emergency ready light on a surface perpendicularly, said multi-function emergency ready light that uses long-life cold-cathode light tube (7) becomes a desk lamp. When said A/C plug of said multi-function emergency ready light is pulled out to become perpendicular to said housing (1), it plugs into an A/C outlet to recharging and said long-life cold-cathode light at end of said housing (1) becomes a little night light. Users may carry this light and use said LED super light bulb (2) for distant lighting at outdoor or indoor. Thus, this renovated light is multi-purpose, energy-saving and environmental friendly. It is an important light source in the police force, fire department, emergency rescue, disciplined army and civil use.

What is claimed is:

1. A multi-function emergency ready light comprises:
a three-dimensional rectangular-cylinder housing, inside of it contains at least five sources of lighting wherein three of said sources of lighting are LED, power saving illuminants; and
a plurality of reflector is fixed around said mean of light source; and
a transparent front flat board; and
a plurality of heat release covers attached at the end portion of said housing; and
a sealed packing collar is connecting a inner portion of said transparent front flat board and said reflector which resides inside of an annular nut, said annular nut providing a fixed position and a disassembled position on front portion of said housing; surface of said annular nut, which is located in front of said housing, set an annular shockproof nut.

2. A multi-function emergency ready light comprises:
a rectangular housing, inside of it contains at least seven lighting sources wherein six of said lighting sources are LED; and
a plurality of convex reflector is fixed around said mean of light source; and
a plurality of transparent front flat board; and
a plurality of seal packing collar is connecting an inner portion of said transparent front flat board and said reflector which resides inside of a plurality of annular nut, and said plurality of annular nut providing a fixed position and a disassembled position on front portion of said housing. Surface of said annular nut, which is located in front of said housing, set of plurality of annular shockproof nut; and it is made of rubber or other soft material to prevent said rechargeable halogen lantern from shocks or quakes when excessive external force applied to it.

3. A multi-function emergency ready light as recited in claim 1, wherein, said multi-function emergency ready light is further comprises:
at least one energy-saving light bulb, and
at least three LED
at least one arc shaped reflector,
at least one set of main switch,
at least one power receptacle for external electricity,
at least one transformer, and
at least one set of circuitry and power supply.

4. A multi-function emergency ready light as recited in claim 1, wherein said multi-function emergency ready light is a light, further comprising: a light housing to which said arc lamp is stationary mounted; a reflector housing to which said reflector is mounted; a reflector positioner comprising a threaded coupling between said light housing and said reflector housing enabling longitudinal displacement of said reflector relative to said light housing by said user manipulation; and a fluted heat sink mounted on said light housing, wherein said housing conductively dissipates lamp heat from said anode.

5. A multi-function emergency ready light as recited in claim 1, wherein said multi-function emergency ready light comprises at least five lighting sources, which is having one energy saving halogen light bulb and three LED, said five lighting sources are located on a light base; wherein electricity is provided by a power source within said housing and said electricity current goes through power cord to the insides of electrical circuitry of said housing and transformer, while connects power receptacle, on/off switch, and links up with energy saving florescent bulb.

6. A multi-function emergency ready light as recite in claim 1, wherein a multi-function emergency ready light further comprises:
a rectangular housing, inside of it contains a mean of lighting source;
a plurality of reflector is fixed around said mean of light source; and
a plurality of transparent front flat board; and
a plurality of seal packing collar is connecting an inner portion of said transparent front flat board and said reflector which resides inside of a plurality of annular nut; said plurality of annular nut providing a fixed position and a disassembled position on front portion of said housing; wherein surface of said annular nut, which is located in front of said housing, set of plurality of annular shockproof nut. It is made of rubber or other soft material to prevent said rechargeable halogen lantern from shocks or quakes when excessive external force applied to it.

7. A multi-function emergency ready light as recited in claim 1, wherein said multi-function emergency ready light further comprises:
a handle in a rectangular shape is longitudinally attached to said housing, wherein a front and rear of the handle are equipped with stripes so as to provide a mean of carrying.

8. A multi-function emergency ready light as recited in claim 1, wherein said multi-function emergency ready light further comprises:
a heat release cover is located at rear portion of said housing, and
metal screws tightly locked a heat release cover to the rear bump of said housing, and
a seal packing collar fastens the light fixture's rear inside with a front end of said heat release cover, said heat release cover provides disassembling position or a fixed position at rear portion of said housing, batteries can be changed when said heat release cover and said housing are separated, wherein surface of said heat release cover contains a rubber or soft material made sealing nut, there is a lid on said sealing nut that can seal the entrance of said external receptacle, thus prevent water and is more durable.

9. A multi-function emergency ready light as recited in claim 2, wherein said multi-function emergency ready light is a light, further comprising: a light housing to which said arc lamp is stationary mounted; a reflector housing to which said reflector is mounted;
a reflector positioner comprising a threaded coupling between said light housing and said reflector housing enabling longitudinal displacement of said reflector relative to said light housing by said user manipulation;
and a fluted heat sink mounted on said light housing, wherein said housing conductively dissipates lamp heat from said anode.

10. A multi-function emergency ready light as recited in claim 2, wherein said multi-function emergency ready light comprises a lighting source, has an energy saving light bulb, which is located on a light base, wherein electricity is provided by a power source within said housing, said electricity current goes through power cord to the insides of electrical circuitry of said housing and transformer, while connects power receptacle, on/off switch, and links up with energy saving halogen bulb.

11. A multi-function emergency ready light as recited in claim 2, wherein multi-function emergency ready light can draw electricity either from AC power outlet provided from public utility or from the chargeable heat release directly.

12. A multi-function emergency ready light as recited in claim 1, wherein said multi-function emergency ready light further comprises:
a handle in a rectangular shape is longitudinally attached to said housing. A front and rear of the handle are equipped with stripes so as to provide a mean of carrying.

13. A multi-function emergency ready light as recited in claim 1, wherein said multi-function emergency ready light further comprises:
a heat release cover is located at rear portion of said housing, and metal screws tightly locked a heat release cover to the rear bump of said housing, and a seal-packing collar fastens the light fixture's rear inside with a front end of said heat release cover; wherein said heat release cover provides disassembling position or a fixed position at rear portion of said housing; batteries can be changed when said heat release cover and said housing are separated, wherein surface of said heat release cover contains a rubber or soft material made sealing nut, and there is a lid on said sealing nut that can seal the entrance of said external receptacle, thus prevent water and is more durable.

14. A multi-function emergency ready light as recite in claim 2, wherein a multi-function emergency ready light further comprises:
a rectangular housing, inside of it contains a mean of lighting source;
a plurality of reflector is fixed around said mean of light source; and
a plurality of transparent front flat board; and
a plurality of seal packing collar is connecting an inner portion of said transparent front flat board and said reflector which resides inside of a plurality of annular nut; said plurality of annular nut providing a fixed position and a disassembled position on front portion of said housing; wherein surface of said annular nut, which is located in front of said housing, set of plurality of annular shockproof nut. It is made of rubber or other soft material to prevent said rechargeable halogen lantern from shocks or quakes when excessive external force applied to it.

15. A multi-function emergency ready light as recited in claim 2, wherein, said multi-function emergency ready light is further comprises:
at least one energy-saving light bulb, and
at least six LED
at least one arc shaped reflector,
at least one set of main switch,
at least one power receptacle for external electricity,
at least one transformer, and
at least one set of circuitry and power supply.

16. A multi-function emergency ready light as recited in claim 1, wherein said multi-function emergency ready light is a light, further comprising: a light housing to which said arc lamp is stationary mounted; a reflector housing to which said reflector is mounted; a reflector positioner comprising a threaded coupling between said light housing and said reflector housing enabling longitudinal displacement of said reflector relative to said light housing by said user manipulation; and a fluted heat sink mounted on said light housing, wherein said housing conductively dissipates lamp heat from said anode.

17. A multi-function emergency ready light as recited in claim 2, wherein said multi-function emergency ready light further comprises:
a heat release cover is located at rear portion of said housing, and
metal screws tightly locked a heat release cover to the rear bump of said housing, and
a seal packing collar fastens the light fixture's rear inside with a front end of said heat release cover, wherein said heat release cover provides disassembling position or a fixed position at rear portion of said housing; batteries is changed when said heat release cover and said housing are separated; surface of said heat release cover contains a rubber or soft material made sealing nut, wherein there is a lid on said sealing nut that can seal the entrance of said external receptacle, thus prevent water and is more durable.
